(19) United States
(12) Patent Application Publication
(10) Pub. No.: US 2012/0248099 A1
(43) Pub. Date: Oct. 4, 2012

(54) ENCLOSED OFFSHORE TANK FOR STORING CRUDE OIL

(75) Inventors: Nagendran C. Nadarajah, Kuala Lumpur (MY); Renata Anita De Raj, Kuala Lumpur (MY); Mahendran Suppiah, Kuala Lumpur (MY); Ionel Valeriu Grozescu, Kajang (MY)

(73) Assignee: KINGTIME INTERNATIONAL LIMITED, Singapore (SG)

(21) Appl. No.: 13/505,435

(22) PCT Filed: Nov. 16, 2009
(86) PCT No.: PCT/MY2009/000194

§ 371 Date: Jun. 19, 2012

(51) Int. Cl. H05B 6/64

(52) U.S. Cl. 219/756

(57) ABSTRACT

An enclosed offshore tank for storing crude oil in a flowable form where the problems associated with flow assurance are prevented. The enclosed offshore tank includes a floor, an insulated cover and perimeter wall secured to a floor forming the offshore tank. The enclosed offshore tank can include a means of floor heating, wherein the floor is provided with piping which receives heated fluid to heat the crude oil. The perimeter wall can have an inner wall and an outer wall forming an annulus, wherein a heated fluid from a heating source fills the annulus to heat the crude oil. A microwave heating system can include at least one microwave generator, at least one waveguide and at least one radiating element to indirectly heat crude oil in the offshore tank.

### FIELD OF INVENTION

The present invention relates to an enclosed offshore tank for storing crude oil.

### BACKGROUND ART

Oil and gas produced from offshore wells must be transported from the production site to land-base for subsequent refining and storing. Transportation facilities for subsequent processing are also needed. In some areas such as remote locations far away from existing infrastructures, even in relatively shallow waters, the cost of building a conventional production platform cannot be justified based on the amount of production anticipated from the wells. Accordingly, there are classes of wells that could be economically drilled and oil extracted if the cost of fabricating a suitable production platform is economical. In such cases, an adequate submerged or floating storage facility can make production from the site economically desirable. An example of an economical, mobile offshore oil drilling, production and storage platform (MOPSU) is described in U.S. patent application Ser. No. 12/278,253. MOPSU is a versatile production platform which includes a hull extending above the sea level to house hydrocarbon extracting and scale up or scale down hydrocarbon processing system modules and equipment, with provisions to drill new wells and work-overs using modular portable vertical drilling rigs or conventional rigs, connected to a mat acting as a foundation resting on the seabed and incorporating submerged oil storage facility. Another example is a mobile offshore production unit (MOPUstor) which consists of sinking a tank to seabed for storage with a platform subsequently attached to the tank. A further example is a mobile offshore production unit (MOPU) which is connected to a conventional well head platform and a permanently moored floating storage and offloading (FSO) facility. All of the above examples require a shuttle tanker to periodically offload the stored crude in the storage facilities. In the event that this was not possible then production would seriously be compromised. The above examples will not in certain circumstances be able to store and retrieve crude oil containing wax or crude oil that needs to be kept at an elevated temperature to assist flow assurance. However, operating storage facilities at temperatures where paraffinic particles remains suspended in the crude oil and above the crude oil pour point will assist flow assurance, ensure continuous production and facilitate the storage and retrieval of crude oil. The oil industry commonly assumes that the crude oil can be modelled with the following pseudocomponents: (a) gas, small hydrocarbon molecules, (b) oil, medium size hydrocarbon molecules, and (c) paraffin, large hydrocarbon molecules.

The accumulation of wax in wells, flowlines and storage facilities is a common problem. Waxy deposits consist of very small paraffin crystals that tend to agglomerate and form small granular particles when the crude oil is cooled. Crystallization of paraffin crystals commences when the crude oil temperature is below a particular temperature. This temperature is called cloud point temperature, also known as wax appearance temperature (WAT). At this temperature, the crude is saturated with paraffin and solid paraffin begins to precipitate.

The structure of paraffinic crystals has been shown to vary with carbon number. Paraffins are composed of the following two structures of wax crystals: (a) macrocrystalline structures which consist of 20 to 50 carbon atoms and (b) microcrystalline structures which consist of 50 to 80 carbon atoms. Crystal growth and morphology of these two types of waxes are different.

Macrocrystalline wax crystals are large needle-shape crystals (n-alkanes) which agglomerate and form large masses. Microcrystalline or amorphous wax crystals have many side branches which have little tendency to agglomerate. A large majority of oil-field paraffins are composed of both crystals.

The crystals formed can develop an interlocking 3D structure that can entrap other materials such as resins, crude oil and in many instances, water. Hardness and strength of this 3D structure depends on the composition of the paraffin crystals and amount of crude oil entrapped. If shear strength of the wax deposited at a wall of a pipe exceeds shear strength imposed on it, a flow barrier is created in the pipe.

There are two mechanisms that cause paraffin precipitation. An obvious mechanism is the reduction of the heat contained in the crude oil, which lowers its temperature below the WAT. Another common but still not widely understood mechanism that causes paraffin precipitation is the evolution of gas. Dissolved gas in the crude oil can act as a paraffin solvent. When free gas evolves, the relative amount of solvent decreases, which in turn causes an increase of paraffin concentration above crude oil maximum solubility level.

Since cloud point temperature directly depends on amount of gas, oil and paraffin present in the crude oil, it has been used as a means to characterize the paraffin concentration of crude. The pour point temperature is also commonly used to characterize paraffinic crudes. Another characterization parameter, weight percent of paraffin in crude oil, has also been used to define when paraffin deposition will occur. Weight percent of paraffin in crude oil can vary from low concentration of oil with less than 1% to high concentration of oil with more than 30%. From published data, an average weight percent of 8 to 12% was obtained for oil that will have paraffin deposition problems. In the past, many literature reviews stated that oils with a paraffin concentration level above 10% can cause severe deposition and flow problems. However, even low paraffin content crudes (less than 1%) can have severe deposition problems. Presently, the weight percent of paraffin is considered an inaccurate way to predict paraffin deposition; in fact the WAT point is a much more accurate means. Cloud point temperatures have been documented to be as low as −17.8° C. (0° F.) and as high of 93.3° C. (200° F.). However, a typical cloud point temperature range between 21.1° C. (70° F.) to 37.8° C. (100° F.).

Although, for many years, wax properties of oils have been characterized by cloud point and pour point measurements, these measurements give only a general understanding of temperatures at which wax deposition and crude oil gelling will become a problem. However, in recent years, wax deposition predictions have expanded upon these empirical tests. It is believed that the key to wax deposition prediction is a precise analysis of concentration of normal paraffins in the crude oil sample.

Crystallization of paraffin can be divided into three stages. The first is nucleation stage. Formation of crystalline nuclei, nucleation, is a process that will determine the product crystal size distribution. When nucleation occurs and temperature stays below nucleation temperature and inside metastable zone, in this stage, the homogeneous nuclei of crystal appear and the crystal paraffin will increase. The second stage is crystal growth in which mass transport of solute in the nuclei direction occurs. The third possible stage is agglomeration in which joining of growing crystals occurs, creating agglomerates with larger dimensions.

Laboratory tests and field experiments confirmed theoretical studies that support four depositional mechanisms: (a) Brownian diffusion deposition, (2) gravity settling deposition, (3) diffusion dispersion deposition and (4) shear dispersion deposition.

Brownian diffusion produces a transport of small paraffinic particles toward colder surfaces of the crude oil facilities, where they are deposited. When these particles exist in the oil, they are randomly hit by thermally excited oil molecules. This impact creates a small Brownian motion of the suspended solid paraffin particles. Brownian diffusion deposition could appear in crude oil flow lines and storage facilities. However, the mass transport due to the Brownian motion is small enough to be neglected by many researchers.

Gravity settling deposition can contribute a substantial amount of paraffin to the deposit in the horizontal flow lines and the storage facilities.

Diffusion dispersion is a mass transport mechanism which occurs due to the difference in densities of separate regions of the crude oil. Diffusion mechanism is driven by a concentration gradient, which could be established by the presence of a temperature gradient. Saturated oil at high temperatures can contain more paraffin in solution than colder saturated oil since the solubility limit of the paraffin increases with the temperature. This concentration gradient drives paraffin particles in solution towards the region of the production facility which has a lower temperature than its neighbouring region. This mass transport will increase the paraffin concentration above the solubility limit. When this occurs, some of the precipitated paraffin sticks to the colder surfaces creating paraffin deposits. This deposition mechanism is common for production flow lines and the storage facilities. However, it is not characteristic for a vertical flow line.

Shear transport mechanism is driven by the velocity gradient. When small particles are suspended in a fluid that is in laminar motion, the particles tend to move at the mean speed and in the direction of the surrounding fluid. Movement of the particles transverse to the direction of the local flow can arise, however, due to the mutually induced velocity fields which occur during shear flow. This mechanism has been documented to contribute a substantial amount of paraffin deposition depending on the shear rate. The rate of shear deposition is directly proportional to the shear rate. Shear deposition only occurs during a turbulent flow.

A number of factors that can affect the rate of deposition of paraffin in flow lines and storage facilities have been identified in publicly available literature. Some of these factors are temperature of the crude bulk, temperature of the walls, quality of the cooling surfaces (roughness), flow rate, residence time, wax concentration, and the growth and nucleation kinetics.

The formation of the paraffin deposits in heat exchange surfaces, in other words the formation of deposits in subsea pipelines, and in the bulk of the fluid, can seriously jeopardise petroleum production. Build-up of wax over time can eventually reach a point where flow rates are restricted.

Once the paraffin deposition on a surface is formed, it will act as a thermal insulation of the systems. This is not surprising since the thermal conductivity of the wax was found to be 0.25 W/mK which is similar to the thermal conductivity of the many subsea insulation materials. For example, the commercially available insulation material Alderley Material's ContraTherm C55 Subsea System has a thermal conductivity of 0.15-0.20 W/m·K.

If control of wax deposition is not effective, the wax deposits can build up significantly with time and cause disruption of production, reduction of throughput or reduction of storage volume and the inability to offload the stored crude. Subsea pipeline, production and storage facilities are susceptible to wax deposits and asphaltene precipitates, induced by lower temperatures.

Wax deposits relatively slowly and, in addition, deposition can be controlled by controlling system temperature and temperature differential at the pipe or storage facilities walls. If the system is operated at a temperature approximately 5-11° C. (10-20° F.) above the cloud point, wax will not deposit. A frequently used principle in providing guidance in operating crude oil facilities is 8° C. (15° F.) above cloud point. Although this can usually be achieved naturally for wellbores and wellheads installed on the seabed, it is often not possible to maintain this high temperature in topside facilities. Oil temperature arriving at different facilities may be limited due to processing concerns or by the temperature rating of equipment. During late life, reservoir temperature may drop to a point that oil arrival temperatures are substantially below the cloud point leading to significant deposition.

The rate of deposition can be reduced at production facilities by a suitable insulation and by injection of chemicals or microbes. It is documented that chemical injection can reduce deposition rates by up to five times. However, it must be emphasized that these chemicals do not completely stop the deposition of wax.

Wax control guidelines for sub-sea systems can be summarized as follows:
(1) Avoiding wax deposition in the wellbore and tree by operating the well at sufficiently high flow rates;
(2) Identifying and treating high pour point oils continuously;
(3) Removing the wax from flow-lines by pigging, ensuring pigging is done frequently enough to guarantee that the pigging equipment does not get stuck;
(4) Utilizing insulation and chemicals to reduce pigging frequency.

Based on the above there is an urgent requirement to design an offshore storage facility which can be operated with minimum intervention, reduced maintenance and built in redundancy to ensure that the flow assurance of the stored crude oil is not compromised to enable it to be offloaded. The design will incorporate features which will maintain the stored crude oil in a homogenised state and maintain the temperatures at predetermined levels to prevent the deposition of wax or to assist flow assurance of crude oil without wax requiring maintenance at elevated temperatures. This will assist flow assurance, ensure continuous production and facilitate the storage and retrieval of crude oil.

### SUMMARY OF THE INVENTION

The present invention relates to an enclosed offshore tank for storing crude oil in a flowable form comprising an insulated cover (not shown), floor, a perimeter wall attached or secured to the floor forming the offshore tank. The offshore tank further includes one or a combination of:
i) a floor provided with a piping means connected to a means that supplies the heated fluid from a heating source to heat the crude oil;
ii) a perimeter wall which has an inner wall and an outer wall forming an annulus wherein a heated fluid from a heating source fills the annulus to heat the crude oil;
iii) a microwave heating system that includes at least one microwave generator, at least one waveguide and at least one radiating element to indirectly heat the crude oil in the offshore tank.

The annulus described in (ii) above can alternatively be filled with heat insulating material in the event either option (i) or (iii) above or both are used in isolation which will be the case where the circumstances does not warrant extensive heating which in turn will be dependent upon the characteristics and type of crude oil to be stored and the environmental temperature in which the offshore tank is located.

In the event that all options (i), (ii) and (iii) are used inner surface of the outer perimeter wall will be coated with suitable heat insulating material to prevent heat loss to the environment.

The enclosed offshore tank described above is used for preventing deposition of wax in solid form and for storing crude oil in a flowable form. The offshore tank is suitable for containing paraffinic crude oil or where the crude oil needs to be kept at an elevated temperature for flow assurance. Wax deposition in solid form is avoided by maintaining the crude oil at a temperature of approximately 8° C. above its corresponding wax appearance temperature. Homogenization of the oil and re-suspension of sludge formed is achieved by operating at least one rotary jet mixer at the bottom of the offshore tank.

The piping means receives heated fluid from a heating source. The at least one piping means is connected to at least conduit means which supplies the heated fluid to the piping means. The piping means is embedded in a reinforced concrete layer that radiates heat to the water and/or crude oil in the offshore tank. The reinforced concrete layer embedding the piping means is underlayed with a heat insulating layer to avoid heat loss to environment. The heat insulating layer is protected from damage by a base made of steel plate, reinforced concrete and or any other protecting tank material. The heat insulating layer can take the form of a specialist coating material for e.g. Alderley Material's ContraTherm C55 Subsea System or alternatively can be a mixture of expanded perlite material mixed with concrete.

At least one compartment wall is secured or attached to the perimeter wall to compartmentalize the offshore tank into at least one compartment. The at least one compartment wall includes two layers of wall, wherein one of the two layers is a radiant panel, the other layer being a flat panel sheet spaced apart from the radiant panel creating an annulus. The two layers of wall form an annulus for the heated fluid to flow inside the at least one compartment wall of the offshore tank. The radiant panel is formed at predetermined locations of the at least one compartment wall. The annulus in the perimeter wall and/or at least one compartment wall receives heated fluid from a heating source. The radiator panel forming the annulus of the compartment wall radiates heat from the heated fluid in the annulus to the water and/or crude oil in the at least one compartment. The at least one compartment wall and the perimeter wall is connected to at least one conduit means which supplies heated fluid to the annulus.

The heated fluid heats the crude oil to a temperature of approximately 8° C. or more above wax appearance temperature to prevent deposition of wax. Depending on wax appearance temperature of the crude oil, the heat required to maintain temperature of the crude oil above the wax appearance temperature is generated or supplemented by a microwave heating system.

The microwave heating system includes at least one microwave generator, at least one waveguide and at least one electromagnetic waves radiating element at the bottom of the offshore tank. The at least one microwave generator generates transverse electromagnetic waves which are transmitted through the at least one waveguide to the at least one radiating element. The at least one waveguide comprises of at least one coaxial cable or at least one metallic tubular conduit. Absorption of the microwave by water layer existing at bottom of the offshore tank causes an increase of the water temperature and subsequently an increase of the temperature of the crude oil in contact with the water. Alternatively, where there is no presence of water in the offshore tank, attenuation and dissipation of microwaves in the crude oil generates locally concentrated heat at specific locations where wax exists. A person skilled in the art will be able to determine the operating parameters of the microwave system.

The enclosed offshore tank includes at least one agitator for dissolving and suspending sludge that may accumulate in the offshore tank.

The enclosed offshore tank can be a sub-sea storage tank for storing crude oil in a flowable form. The sub-sea storage tank is connected to at least one connecting leg that is connected to hull of a mobile offshore production platform. The connecting leg includes conduit means to introduce or offload the crude oil and a conduit means to introduce or offload water into or from the offshore tank. The connecting leg further includes at least one waveguide comprises of at least one coaxial cable or at least one metallic tubular conduit that is connected from the microwave generator.

The enclosed offshore tank can be integrated or incorporated in a single or multiple units in a floating production storage offloading vessel or a floating storage offloading vessel. The enclosed offshore tank can also be a single or multiple units of a cylindrical floating tank.

### BRIEF DESCRIPTION OF THE DRAWINGS

The present invention will be more fully understood from the detailed description given herein below and accompanying drawings which are given by way of illustration only, and thus are not limitative of the present invention, wherein:

FIG. 1 shows a perspective view of the sub-sea storage tank with top cover removed showing rectangular and L-shaped compartments;

FIG. 2 shows a diagrammatic view of a L-shaped compartment including radiant wall and floor heating means with the top cover and floor removed for purposes of clarity;

FIG. 3 shows a diagrammatic view of a L-shaped compartment fitted with a submerged rotary jet mixer system dispersing crude oil across the tank floor preventing or re-suspending the accumulated sludge with the top cover removed;

FIG. 4 shows a top view of the sub-sea storage tank showing the location of rotary jet mixers in the rectangular and L-shaped compartments with the top cover removed;

FIG. 5 shows an isometric view of floating storage and offloading facility vessel with crude oil storage compartments with radiant floor and wall heating with the top cover removed;

FIG. 6 shows a diagrammatic view of a rectangular crude storage tank with radiant wall and floor heating in the floating production storage and offloading facility vessel with the top cover removed;

FIG. 7 shows a perspective view of an offshore cylindrical floating storage tank attached to a mobile offshore production and storage unit;

FIG. 8 shows a top view of an offshore cylindrical floating storage tank; and

FIG. 9 shows a diagrammatic view of a cylindrical floating storage tank compartment fitted with radiant wall and floor heating system with the top cover removed; and

FIG. 10 shows a diagrammatic view of a microwave heating system used in the sub-sea storage tank.

### DETAILED DESCRIPTION OF THE PREFERRED EMBODIMENT

A variety of techniques have been employed in order to reduce problems associated with flow assurance caused by various reasons including crystallization of paraffin during production, transportation and/or storage of crude oil. Rate of paraffin/wax deposition in an enclosed offshore tank or storage system can be reduced by injection of paraffin/wax dispersant chemicals, which can reduce deposition rates by up to five times. However, operating an enclosed offshore tank storing crude oil at temperatures above wax appearance temperature is preferable. In the present invention, the term paraffin and wax are used interchangeably. The present invention relates to an enclosed offshore tank requiring minimum intervention and built in redundancy for storing crude oil in a flowable form where the problems associated with flow assurance are prevented. The enclosed offshore tank comprises a floor, an insulated top cover and perimeter wall secured to a floor forming the offshore tank. In certain circumstances, even crude oils without paraffin/wax can have higher than expected pour points, requiring the crude oil to be heated and maintained at an elevated temperature for flow assurance. The enclosed offshore tank described in the present invention also addresses such circumstances. The enclosed offshore tank includes one or a combination of:
i) the floor provided with a piping means connected to a means that supplies the heated fluid from a heating source to heat the crude oil;
ii) the perimeter wall which has an inner wall and an outer wall forming an annulus wherein a heated fluid from a heating source fills the annulus to heat the crude oil;
iii) the microwave heating system that includes at least one microwave generator, at least one waveguide and at least one radiating element to indirectly heat the crude oil in the offshore tank.

The annulus described in (ii) above can alternatively be filled with heat insulating material in the event either option (i) or (iii) above or both are used in isolation which will be the case where the circumstances does not warrant extensive heating which in turn will be dependent upon the characteristics and type of crude oil to be stored and the environmental temperature in which the offshore tank is located.

In the event that all options (i), (ii) and (iii) are used inner surface of the perimeter wall (34) will be coated with suitable heat insulating material to prevent heat loss to the environment.

The heated fluid used in the present invention is water or any heat transferable flowable material, and the preferred heat insulating material is either Alderley Material's ContraTherm if used as a coating or expanded perlite particles which are commercially available and widely used because of its low thermal conductivity, cost, ease of handling, nonflammability and low moisture if used to fill the annulus. In addition, the perlite particles can be mixed with concrete to form an effective insulating material. Re-suspension of the paraffin/wax deposits is obtained using an agitator or mixer such as a Veolia P43 rotary jet mixer. The offshore tank heats the crude oil containing paraffin/wax to a temperature of approximately 8° C. or more above wax appearance temperature (WAT) to prevent the deposition of paraffin/wax. In the case of crude oil without wax, this temperature will be dependent on the crude oil properties. A detailed description of preferred embodiments of the invention is disclosed herein. It should be understood, however, that the disclosed preferred embodiments are merely exemplary of the invention, which may be embodied in various forms. Therefore, the details disclosed herein are not to be interpreted as limiting, but merely as the basis for the claims and for teaching one skilled in the art of the invention.

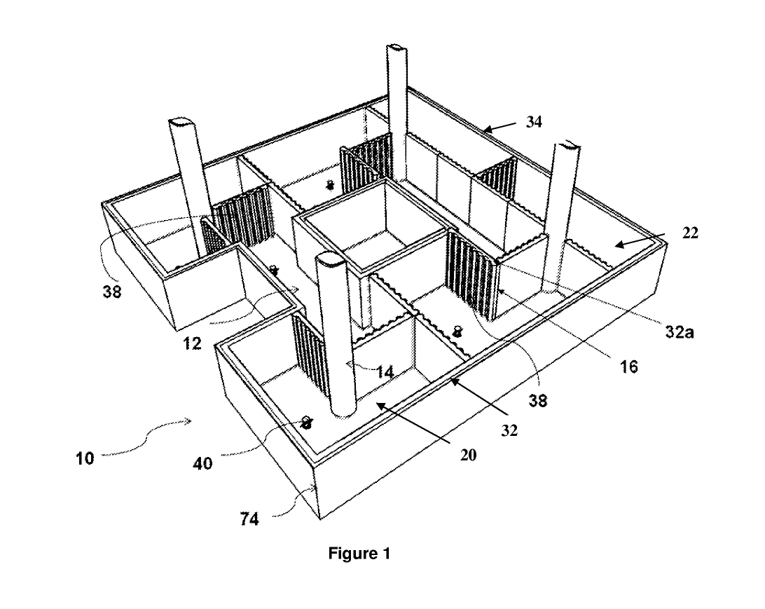

The preferred embodiment of this present invention which relates to an enclosed offshore tank storing crude oil in a flowable form wherein the offshore tank is a sub-sea storage tank (10) as illustrated in FIG. 1. The sub-sea storage (10) tank comprising an insulated cover (19) (not shown), floor (20), perimeter wall (74) secured to the floor forming the offshore tank (10). The sub-sea storage tank includes one or a combination of:
(i) a means of floor heating wherein the floor (20) is provided with a piping means (18) which receives heated fluid (30) to heat the crude oil;
(ii) the perimeter wall (74) has an inner wall (22) and an outer wall (34) forming an annulus (32) wherein a heated fluid (30) from a heating source fills the annulus (32) to heat the crude oil;
(iii) the microwave heating system (58) that includes at least one microwave generator (60), at least one waveguide (62) and at least one radiating element (64) to indirectly heat crude oil in the sub-sea storage tank.

The annulus (32) described in (ii) above can alternatively be filled with heat insulating material in the event either option (i) or (iii) above or both are used in isolation which will be the case where the circumstances does not warrant extensive heating which in turn will be dependent upon the characteristics and type of crude oil to be stored and the environmental temperature in which the offshore tank is located.

In the event that all options (i), (ii) and (iii) are used the inner surface of the perimeter wall will be coated with suitable heat insulating material (36) to prevent heat loss to the environment.

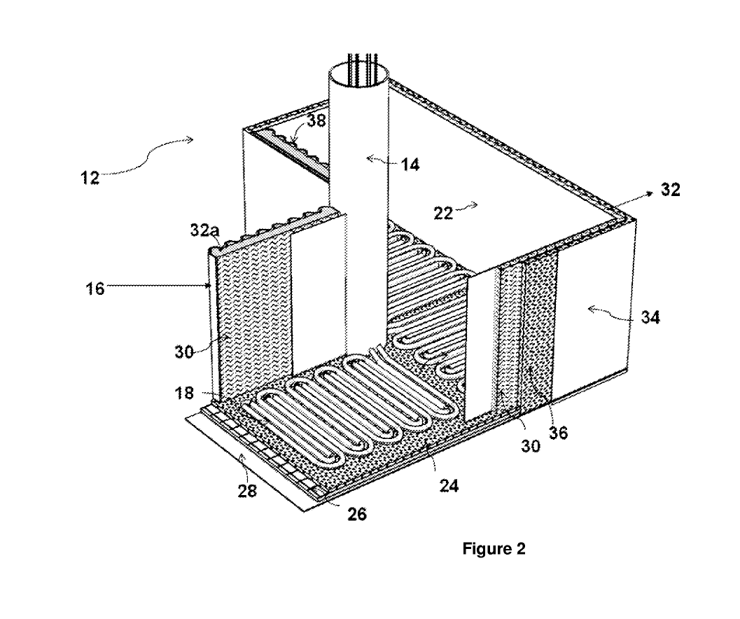

The sub-sea storage tank (10) as shown in FIG. 1 is further compartmentalized with at least one compartment (12). At least one compartment wall (16) is secured or attached to the perimeter wall (74) to compartmentalize the offshore tank into at least one compartment (12). A typical compartment (12) is shown in FIG. 2. The at least one compartment wall (16) is constructed with two layers of walls. One of the layers is formed by a radiant panel (38), the other layer being a flat panel sheet spaced apart from the radiant panel (38) creating an annulus (32a). The at least one compartment (12) can be of L-shape, rectangular shape, square shape, curved or any other shape or combination thereof. The sub-sea storage tank (10) is connected to at least one connecting leg (14) that is connected to a hull of mobile offshore production and drilling platform or mobile offshore production platform. The hull is attached to a deck that holds production facilities and also the at least one microwave generator (60), and power source (70) of the microwave generator (60). Crude oil flows from a production facility located above water surface to the at least one compartment (12) of the sub-sea storage tank (10), through at least one connecting leg (14) via conduit means from the production facility. The annulus in the various compartments can be inter-connected so as to facilitate the free flow of the heated fluid (30) along all the annulus, or can be isolated into sections. In the latter situations each isolated sections of annulus will have independent supply of heated fluid from the conduit means. The connecting leg (14) also includes conduit means (not shown) to offload the crude oil and conduit means (not shown) to introduce or offload water into or from the sub-sea storage tank. The connecting leg further includes at least one waveguide (62) comprises of at least one coaxial cable or at least one metallic tubular conduit. The inner wall (22) and outer wall (34) are made of steel.

FIG. 2 shows the heating system means in an L-shaped compartment. Floor (20) heating is accomplished by means circulating a heated fluid (30) through at least one radiant pipe loop (18) embedded beneath the floor (20). Heat transfer from the floor (20) to the crude oil stored within the compartment (12) depends on both the floor temperature and crude oil temperature. Heat input to the floor (20) will depend on inlet fluid temperature, flow and pipe spacing. The floor (20) of the tank is made of concrete or other material that allows heat transfer from the at least one radiant pipe loop (18). The radiant pipe loop receives heated fluid through the conduit means which is within the connecting leg (14) from a heating source located at the deck or hull.

The radiant pipe loop (18) consists of preferably plastic tubing. The plastic tubing, especially cross-linked tubing has high radiant heating capacity, corrosion resistance, life-span over 100 years and possesses shape memory which only requires addition of heat to return to its original shape. Tubing size and looping pattern are determined based on the heat transfer requirements to crude oil storage compartments. A typical compartment (12) will have preferably at least two radiant pipe loops (18) to provide redundancy in the event that one pipe loop (18) ceases to function. The radiant pipe loop (18) is embedded in a reinforced concrete layer (24) that radiates heat to water or crude oil in the sub-sea storage tank.

A layer of insulating concrete (26) or a rigid heat insulating layer or base providing heat insulation is used to prevent heat loss to the environment. The reinforced concrete layer is insulated by the heat insulating layer (26). Often between the reinforced concrete layer (24) embedding the radiant pipe loop (18) and the insulation concrete layer (26), a polyethylene vapour barrier, (not shown in the embodiment), is installed. The insulating concrete layer (26) is protected by a base (28) made of steel or reinforced concrete, and any tank protecting material such as rubber. This is to protect the sub-sea storage tank base from sharp hard objects in sea bed when it is lowered down to the sea bed.

In order to provide heat transfer and distribution within the perimeter wall (74) and the compartment (12), a wall heating system is used. Heated fluid (30) enters the annulus (32, 32a) of the perimeter wall (74) and the compartment wall (16) through at least one conduit (not shown) placed within the connecting leg (14) to heat the crude oil. The heated fluid is generated from a heating source located at the hull or deck of the mobile offshore production platform or mobile offshore production and drilling platform. The heated fluid (30) fills up from the bottom of the annulus (32, 32a) to the top where it returns to heaters at the deck. Thermal insulation of the outer wall (34) and cover (19) (not shown) to prevent or minimize heat loss to the environment is realized using a high-performance insulation and vapour retarder layer (36). For a higher degree of efficiency of the heating system, radiant panel (38) forms a layer of the compartment wall (16). A typical arrangement of the radiant panel (38) for the sub-sea storage tank is shown in FIGS. 1 and 2. For a case where the sub-sea storage tank is a small tank or operating in an environment or in conditions which does not need an extensive wall heating, then the annulus (32) of the perimeter wall (74) is filled with heat insulating material. For this case, further thermal insulation of the perimeter wall is not needed.

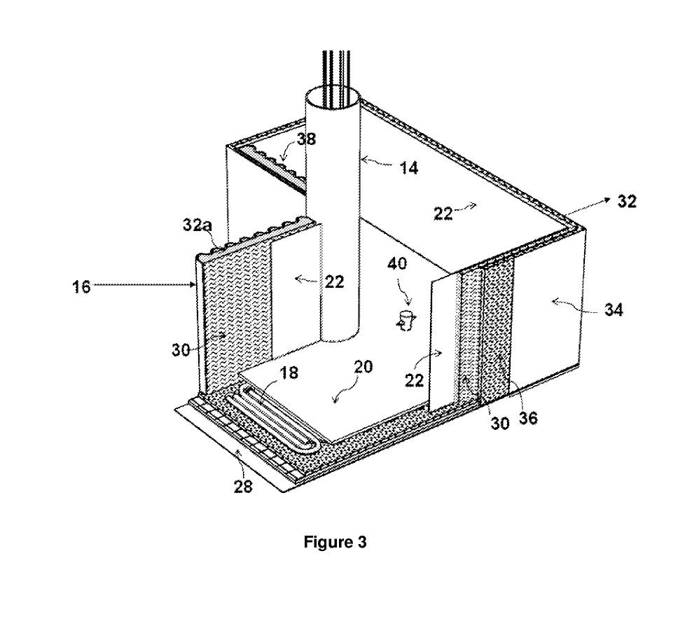

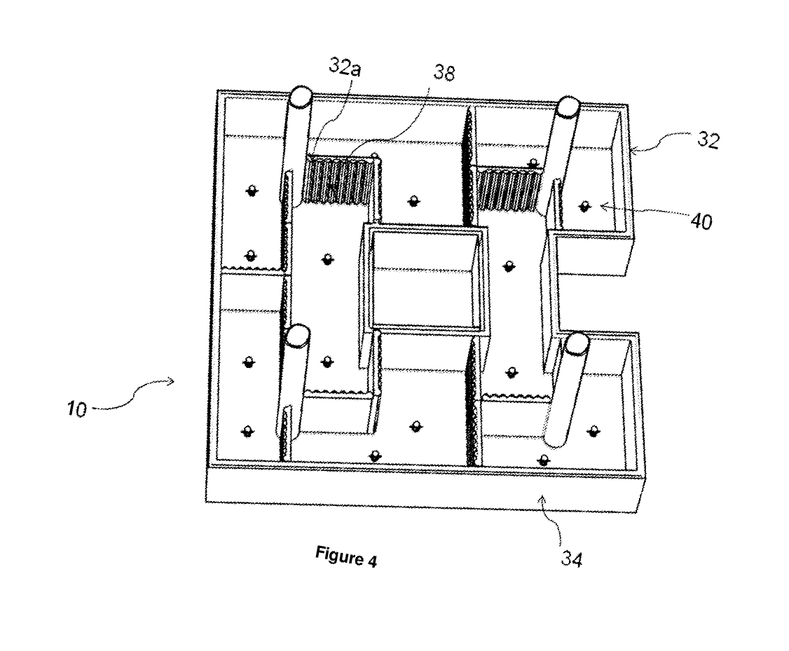

FIGS. 3 and 4 illustrate a crude oil sludge prevention and homogenization system in the crude oil sub-sea storage tank. At least one agitator, such as i.e. rotary jet mixer (40) is installed on the floor of each of the compartment (12). The rotary jet mixer (40) dissolves and suspends sludge that accumulates at bottom of the crude oil sub-sea storage tank. Flow of the crude oil is provided by filling the sub-sea storage tank by known operations. The rotary jet mixer (40) is operated by the flow of crude oil under pressure through the rotary jet mixer, as shown in FIG. 3. Location and the number rotary jet mixers is determined based on the shape and size of the at least one compartment (12). FIG. 4 shows a diagrammatic view of the sub-sea storage tank showing the location of the at least one rotary jet mixer (40) in the rectangular and L-shaped compartments. The at least one agitator is operated independently by force or inflow of crude oil into the sub-sea storage tank.

While the above preferred embodiment is intended for use in storing the crude oil in a subsea storage tank, it does not rule out the use of the offshore tank described above for storing crude oil in a flowable form in a floating storage facility or other types of crude oil storage tanks.

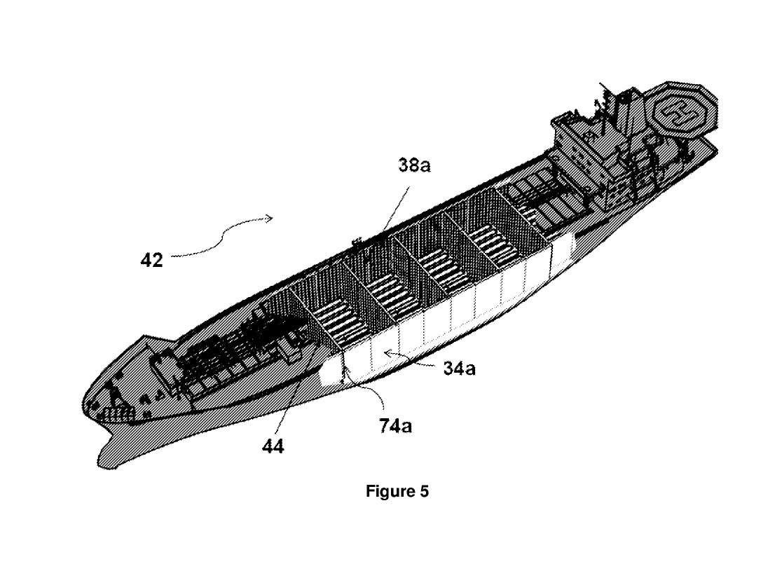

FIG. 5 illustrates a perspective view of a floating storage and offloading vessel (FSO) (42) integrated or incorporated with offshore tank in a single or multiple units (44) as a at least one crude oil storage compartment. The top cover is not illustrated for clarity purposes.

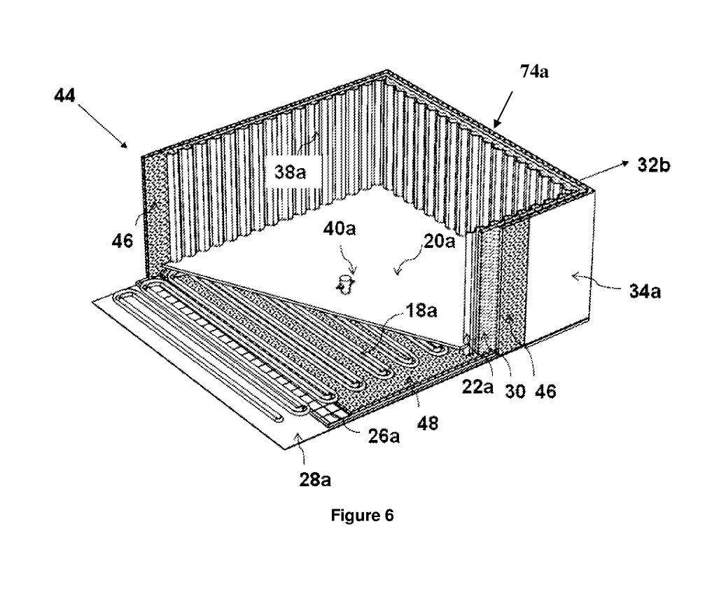

FIG. 6 shows a top cut off view of one of the crude oil storage compartments (44). The at least one crude oil storage compartment (44) is constructed having a cover (not shown), floor (20a), at least one perimeter wall (74a) secured to the floor (20a) forming the crude oil storage compartment (44). The perimeter wall includes an inner wall (22a) and outer wall (34a). A radiant panel (38a) forms the inner wall (22a) of the compartment (44). An annulus (32b) is formed in between the inner wall (22a) and the outer wall (34b). Wall heating is achieved by circulating a heated fluid (30) through the annulus (32b). The outer wall (34a) of the storage compartment (44) is made of steel. Thermal insulation of the outer wall (34a) to prevent or minimize heat loss to the environment is realized using high-performance insulation (46). Floor heating of the storage compartment (44) is accomplished by circulating heated fluid (30) through at least one radiant pipe loop (18a). A reinforced concrete layer of thermal mass (48) is spread over the at least one radiant pipe loop (18a) to facilitate heat transfer to the floor (20a) and consequently to the crude oil. A layer of insulating concrete or heat insulating layer or base providing heat insulation (26a) is used to prevent heat loss to environment. This insulating concrete (26a) is placed in between the reinforced concrete thermal mass layer (48) and inner skin of vessel hull (28a). At least one agitator, for example rotary jet mixer (40a) is installed in the at least one crude oil storage compartment (44) for dissolving and suspending sludge that accumulates in the at least one crude oil storage compartment (44). The agitator is operated independently by force or inflow of crude oil into the storage compartment (44). The radiant pipe loop (18) is connected to a means that supplies the heated fluid (30) from a heating source located at the vessel, i.e. above the storage compartment (44).

As for the microwave heating system for heating the crude oil in the storage compartment (44), at least one microwave generator (60) and the power source (72) are situated at the vessel (42), i.e. above the storage compartment (44). The waveguide (62) allows transmission of transverse electromagnetic (TEM) waves from the microwave generator (60) to at least one electromagnetic wave radiating element (feed horn) (64) placed preferably at bottom of the at least one storage compartment (44) in the vessel (42).

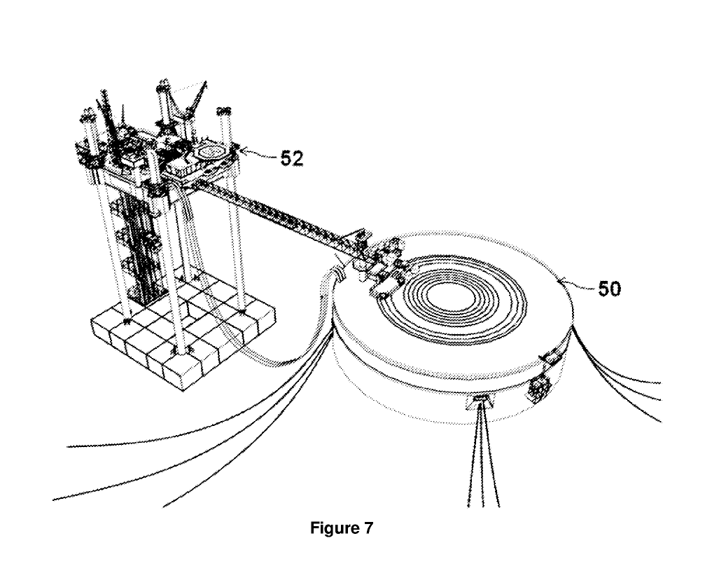

FIG. 7 illustrates another embodiment of the enclosed offshore tank as described above that is integrated or incorporated in a single or multiple units in an oil storage compartment (54) for storing crude oil in a flowable form in a cylindrical storage tank (50). The offshore cylindrical storage tank (50) is connected to a mobile offshore production and storage unit (MOPSU) (52). Crude oil can be stored in submerged storage tank (10) of MOPSU (52) and/or when necessary in the cylindrical storage tank (50). The cylindrical storage tank (50) is a floating storage tank.

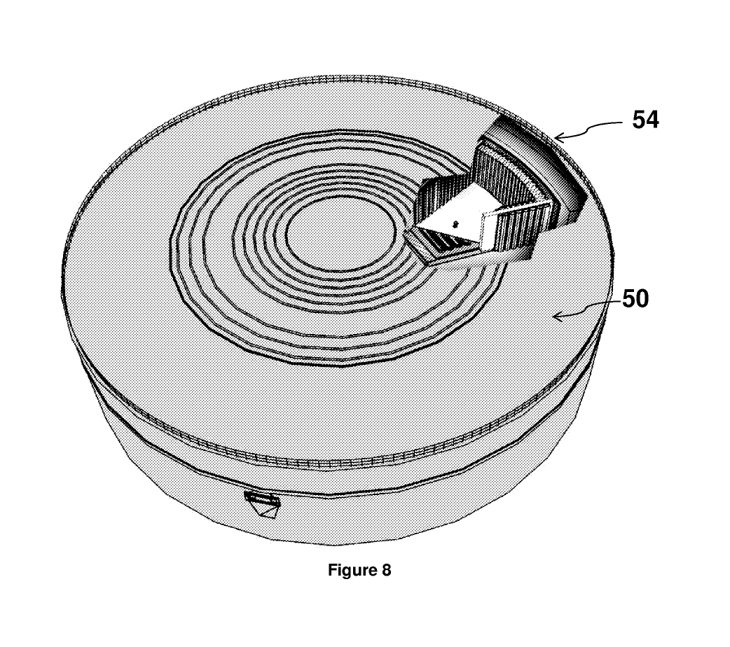

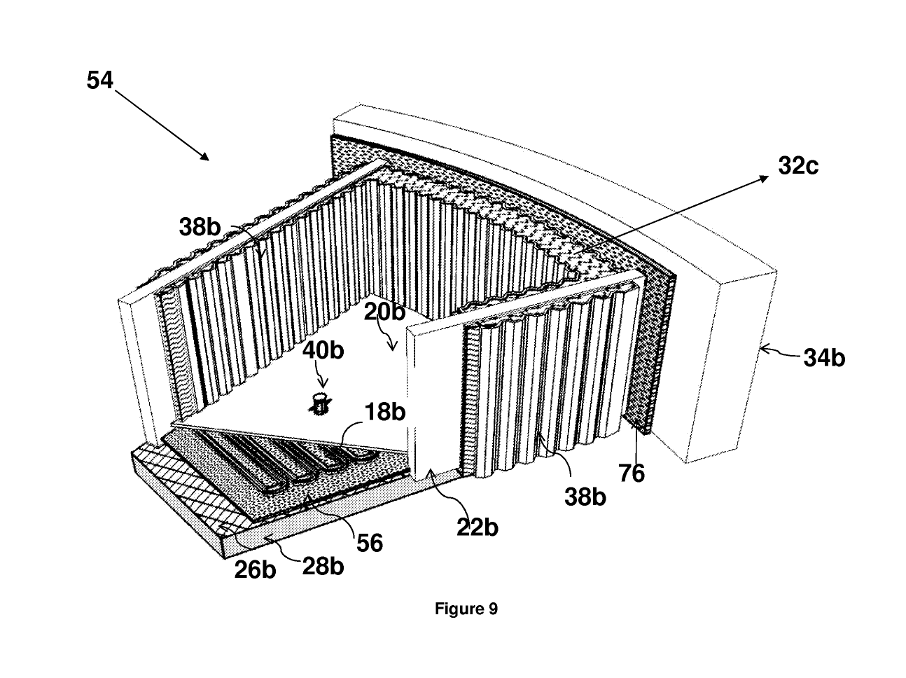

FIG. 8 illustrates an offshore cylindrical floating storage tank (50) with a top view of the crude oil storage compartment (54). FIG. 9 shows a detailed view of a storage compartment (54) of the cylindrical floating storage tank (50) with the top cover not illustrated for clarity purposes. Floor heating of the cylindrical floating storage tank (50) is accomplished by circulating heated fluid (30) through at least one radiant pipe loop (18b) to heat the crude oil. A reinforced concrete layer of thermal mass (56) is spread over the radiant pipe loop (18b) to facilitate the heat transfer to the floor (20b) and consequently to the crude oil. The main structural components of the cylindrical floating storage tank (50), having perimeter wall (34b), inner radial wall (22b) dividing the cylindrical tank into at least two compartments (54) and a base (28b) which is made of reinforced concrete. The inner radial wall (22b) can be of metal lattice structure instead of concrete. This structural configuration of the cylindrical floating storage tank (50) provides rigidity and ensures structural integrity of the storage tank (50). It will be appreciated that inner radial wall (22b) can be metal lattice or steel plate. The wall heating system includes radiant panels (38b) creating an annulus (32c) inside the cylindrical floating storage tank (50). A reinforced concrete layer of thermal mass (76) is laid between the radiant panels (38b) and the perimeter wall (34b). Thermal insulation of the cylindrical floating storage tank (50) is accomplished using insulating concrete layer (26b) situated between a reinforced concrete layer of thermal mass (56) and the base (28b). Insulation concrete can also be used as a layer of the perimeter wall (34b) of the cylindrical tank to avoid or minimize heat loss to the environment. At least one agitator, i.e. rotary jet mixer (40b) is installed in the compartment of the cylindrical floating storage tank (54) for dissolving and suspending the sludge that accumulates in the cylindrical floating storage tank (50).

As for the microwave heating system for heating the crude oil in the storage compartment (54), at least one microwave generator (60) and the power source (72) are situated at the cylindrical floating storage tank (50), i.e. above the storage compartment (54). The waveguide (62) allows transmission of transverse electromagnetic (TEM) waves from the microwave generator (60) to at least one electromagnetic wave radiating element (feed horn) (64) placed preferably at bottom of the at least one storage compartment (54) in the cylindrical floating storage tank (50).

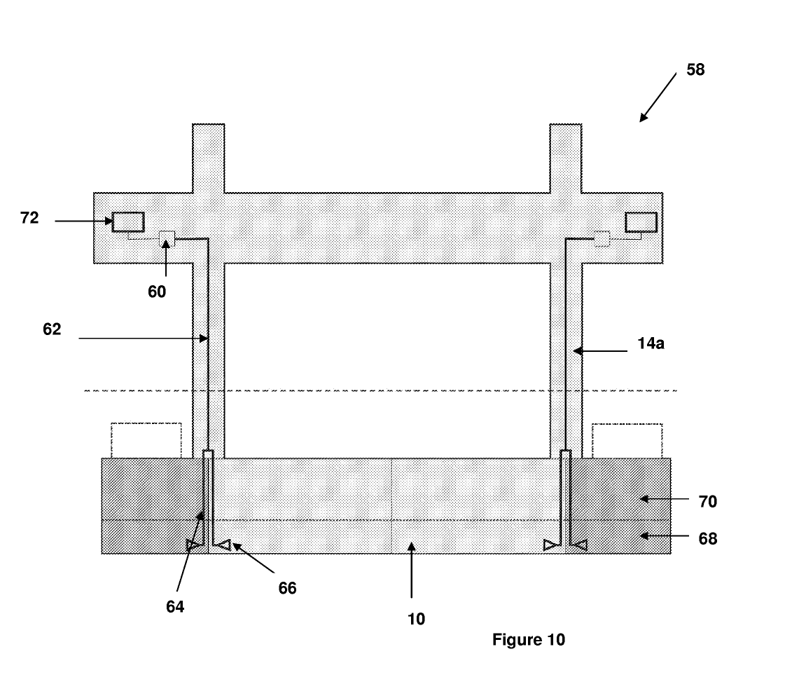

FIG. 10 illustrates a microwave heating system (58) for a sub-sea storage tank (10). The microwave heating system is also suitable for heating crude oil in the offshore tank that are integrated or incorporated in the floating storage and offloading vessel (FSO) (42) and floating production, storage and offloading vessel (FPSO) as at least one storage compartment (44). The microwave heating system is also suitable for heating crude oil in the offshore tank that are integrated or incorporated in the cylindrical floating tank (50) as at least one crude oil storage compartment (54). The offshore tanks (10, 44, 54) are initially used for ballasting and thus filled with water (68) before storing crude oil (70). In the case of offshore tank (10) the water (68) is displaced by crude oil during storage process. The microwave heating system comprises of a microwave generator (60), located at the production facility, a waveguide (62) assembly that allows transmission of transverse electromagnetic (TEM) waves from the microwave generator (60) to at least one electromagnetic wave radiating element (feed horn) (64) placed preferably at the bottom of the offshore tank. As for the sub-sea storage tank (10), at least one waveguide (62) runs through the at least one connecting leg (14a) to the sub-sea storage tank (10). The microwave generator (60) is preferably a low cost device for generating microwaves. Such device, generally designed for industrial applications is the magnetron. The microwave generator (60) is connected to a power source (72). The waveguide (62) consists of at least one coaxial cable or at least one metallic tubular conduit such as electrically-conductive piping. If a magnetron generating electromagnetic radiation with frequency of 2.45 GHz is used, the coaxial cable or metallic tubular conduit with an internal diameter larger than 7 cm is suitable for the propagation of the microwave from the microwave generator (60) to the wave radiating element (64) placed preferably at bottom of the offshore tank.

Heating process is initiated by transmitting the microwaves from a microwave generator (60) to the feed horn (64) through the at least one waveguide (62). The feed horn (64) feeds the microwaves through their open outlet (66) ending into the bottom water (68) region of the offshore tank. Since water (68) is a high-loss dielectric fluid, a substantially large amount of microwave energy is absorbed by the water (68) and indirectly the crude oil (70) is heated. In the case where there is no presence of water in the offshore tank, microwaves will propagate through crude oil as well. Attenuation of the microwaves into the crude oil (70) can be attributed to small dielectric polarization losses in low-loss dielectric materials existing in the offshore tank (10, 44, 54) such as crude oil and large dielectric polarization losses in high-loss dielectric materials such as paraffinic deposits. The attenuation and dissipation of the microwaves generates locally concentrated heat at specific locations where wax deposition occurred. If sufficient heat is generated, wax deposits can be removed.

It will be appreciated from the description, that the heating of the crude oil directly or indirectly by means of either heating the fluid in the annulus, and or heating the floor, and or by microwave heating means and the use of rotary mixers to maintain the stored crude oil in a homogenised state, provide adequate redundancy to assist flow assurance by maintaining flow rates to ensure offloading of the stored crude oil which in turn ensures continuous production and lowering of processing costs. In the event of any malfunction of one system an alternate heating system described can be activated. Depending on operating circumstances each of the heating system can be activated independently of each other. All active components are located in the hull or deck where they can be easily attended to, in the event of failure. This greatly reduces unnecessary downtime and routine maintenance.

Although the invention has been described to specific examples, those skilled in the art will appreciate that the invention may be embodied in many other forms.

1. An enclosed offshore tank for storing crude oil in a flowable form comprising a cover, floor, and a perimeter wall secured to the floor, forming the offshore tank characterized in that wherein the offshore tank further includes
microwave heating system that includes at least one microwave generator, at least one waveguide and at least one radiating element to indirectly heat the crude oil in the offshore tank; and
wherein at least one microwave generator generates transverse electromagnetic waves which is transmitted through the at least one waveguide to the at least one radiating element.

2. (canceled)

3. The enclosed offshore tank for storing crude oil as claimed in claim 1 wherein the offshore tank is integrated or incorporated in a single or multiple units in a floating production storage offloading vessel or a floating storage offloading vessel.

4. The enclosed offshore tank for storing crude oil as claimed in claim 1 wherein the offshore tank is a sub-sea storage tank wherein the sub-sea storage tank is connected to at least one connecting leg that is connected to hull of a mobile offshore production platform.

5. The enclosed offshore tank as claimed in claim 4 wherein the connecting leg includes conduit means to introduce or offload the crude oil and a conduit means to introduce or offload water into or from the offshore tank.

6. The enclosed offshore tank for storing crude oil as claimed in claim 1 wherein the offshore tank can be a single or multiple units of a cylindrical floating tank.

7. The enclosed offshore tank for storing crude oil as claimed in claim 1 wherein the floor is provided with at least one agitator operated independently by force of inflow of crude oil into the tank.

8. (canceled)

9. (canceled)

10. (canceled)

11. (canceled)

12. (canceled)

13. The enclosed offshore tank for storing crude oil as claimed in claim 1 wherein the at least one compartment wall is secured or attached to the perimeter wall to compartmentalize the offshore tank into at least one compartment.

14. The enclosed offshore tank for storing crude oil as claimed in claim 13 wherein the at least one compartment wall includes two layers of wall forming an annulus.

15. The enclosed offshore tank for storing crude oil as claimed in claim 14 wherein the annulus is filled with heated fluid to heat the crude oil.

16. The enclosed offshore tank for storing crude oil as claimed in claim 14 wherein the at least one compartment wall is connected to a means which supplies heated fluid to the annulus.

17. (canceled)

18. The enclosed offshore tank for storing crude oil as claimed in claim 1 wherein the at least one waveguide comprises at least one coaxial cable or at least one metallic tubular conduit.

19. The enclosed offshore tank for storing crude oil as claimed in claim 1 wherein the at least one waveguide runs through at least one connecting leg that is connected from a hull of a mobile offshore production platform to the offshore tank.

20. The enclosed offshore tank for storing crude oil as claimed in claim 1 wherein the at least one waveguide runs from a microwave generator to the offshore tank.

21. The enclosed offshore tank for storing crude oil as claimed in claim 1 wherein the at least one waveguide runs from a microwave generator to the offshore tank.

22. The enclosed offshore tank for storing crude oil as claimed in claim 1 wherein the at least one radiating element includes an outlet to feed the transverse electromagnetic waves into water or crude oil in the offshore tank to heat the crude oil or to heat directly wax deposits within the offshore tank.

23. The enclosed offshore tank for storing crude oil as claimed in claim 22 wherein the crude oil is heated to a temperature that prevents deposition of wax.

24. The enclosed offshore tank for storing crude oil as claimed in claim 4 wherein the at least one waveguide runs through at least one connecting leg that is connected from a hull of a mobile offshore production platform to the offshore tank.

25. The enclosed offshore tank for storing crude oil as claimed in claim 3 wherein the at least one waveguide runs from a microwave generator to the offshore tank.

26. The enclosed offshore tank for storing crude oil as claimed in claim 6 wherein the at least one waveguide runs from a microwave generator to the offshore tank.
